(19) United States
(12) Patent Application Publication
(10) Pub. No.: US 2006/0255082 A1
(43) Pub. Date: Nov. 16, 2006

(54) DETACHABLE FASTENING APPARATUS

(76) Inventor: David Tsai, Chang Hua City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/908,451

(22) Filed: May 12, 2005

(51) Int. Cl. B60R 9/00; B60R 11/00; B60R 7/00

(52) U.S. Cl. 224/403; 224/567

(57) ABSTRACT

A fastening apparatus includes an installing device, a first fastening device and a second fastening device. The installing device is used for installment on a truck. The first fastening device is provided on the installing device for fastening a rope. The second fastening device is provided on the installing device for fastening a front fork of a bicycle.

### BACKGROUND OF THE INVENTION

1. Field of Invention

The present invention relates to a detachable fastening apparatus and, more particularly, to a detachable fastening apparatus for use on a truck.

2. Related Prior Art

As disclosed referring to FIGS. 3 and 4 and claimed in Taiwanese Patent Publication No. 134790, an apparatus for tying a rope on a truck includes a hooking device 20, a pad 21 and a clip 22. The hooking device 20 includes an ear 201, a plate 202 on which the ear 201 is formed, and a screw 203 raised from the plate 202. In operation, the screw 203 is inserted in an aperture defined in a flat portion of a truck. The plate 202 and the pad 21 are put on two opposite sides of the flat portion of the truck. Through operating the clip 22, the flat portion of the truck is clamped between the plate 202 and the pad 21. A rope is tied to the ear 201. Thus, cargos are fastened on the truck by the rope.

FIG. 1 of the drawings attached to the present patent application shows an apparatus 1 for fastening a bicycle on a truck. The conventional apparatus 1 includes a base 2, a restraining device 3 and a screw 4. In operation, the conventional apparatus 1 is installed on a plank-portion of a truck by means of the base 2 and the screw 4. To fasten the bicycle on the truck, the front wheel is taken from the front fork of the bicycle. The front fork is held by means of the restraining device 3.

The apparatus claimed in Taiwanese Patent Publication No. 134790 is only useful in hooking a rope on a truck. The apparatus of FIG. 1 is only useful in fastening a bicycle on a truck. A driver may want to fasten cargos on his or her truck sometimes and fasten a bicycle on the truck some other times. The driver must buy both of the apparatuses, and they cost a lot totally. Moreover, one of the apparatuses must be detached from the truck before the other apparatus can be installed on the truck, and this is troublesome.

The present invention is therefore intended to obviate or at least alleviate the problems encountered in prior art.

### SUMMARY OF THE INVENTION

According to the present invention, a fastening apparatus includes an installing device, a first fastening device and a second fastening device. The installing device is used for installment on a truck. The first fastening device is provided on the installing device for fastening a rope. The second fastening device is provided on the installing device for fastening a front fork of a bicycle.

An advantage of the fastening apparatus according to the present invention is the provision of two functions at a low cost.

Another advantage of the fastening apparatus according to the present invention is its easy operation.

Other advantages and novel features of the invention will become more apparent from the following detailed description in conjunction with the drawings.

### BRIEF DESCRIPTION OF THE DRAWINGS

The present invention will be described through detailed illustration of embodiments referring to the drawings.

FIG. 1 is a perspective view of a conventional detachable fastening apparatus for fastening a bicycle to a truck.

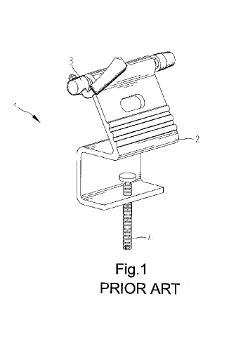

FIG. 2 is a perspective view of a fastening apparatus according to a first embodiment of the present invention.

FIG. 3 is an exploded view of the fastening apparatus shown in FIG. 2.

FIG. 4 is a side view of a truck on which cargos are fastened by means of a plurality of fastening apparatuses shown in FIG. 2.

FIG. 5 is an enlarged partial view of the truck shown in FIG. 4.

FIG. 6 is a side view of a truck on which a bicycle is fastened by means of the fastening apparatus shown in FIG. 2.

FIG. 7 is an enlarged partial view of the truck shown in FIG. 6.

FIG. 8 is an exploded view of a fastening apparatus according to a second embodiment of the present invention.

FIG. 9 is an exploded view of a fastening apparatus according to a third embodiment of the present invention.

### DETAILED DESCRIPTION OF EMBODIMENTS

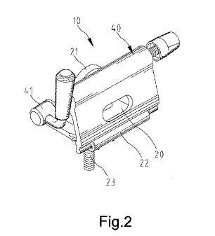

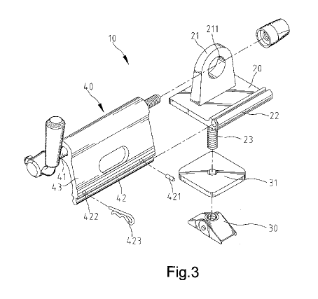

Referring to FIGS. 2 and 3, according to a first embodiment of the present invention, a detachable fastening apparatus 10 includes a plate 20, screw 23 raised from a lower side of the plate 20, a pad 31, a clip 30, a first fastening device 20 and a second fastening device 40.

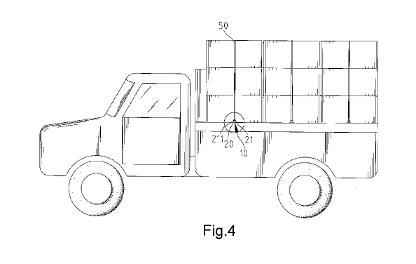

In operation, the screw 23 is inserted in an aperture defined in a flat portion of a truck (FIG. 4). The plate 20 and the pad 31 are put on two opposite sides of the flat portion of the truck. The clip 30 is driven along the screw 23 until the flat portion of the truck is sandwiched by means of the plate 20 and the pad 31. Finally, the clip 30 is operated in order to clamp the flat portion of the truck between the plate 20 and the pad 31.

The first fastening device 21 is an ear formed on an upper side of the plate 20. The ear 21 defines an aperture 211 through which a rope 50 can be inserted (FIG. 4).

The second fastening device 40 includes a plank 43, a slide 42 formed along a lower edge of the plank 43 and a restraining device 41 provided on the plank 43. The slide 42 is slid in a groove 22 defined in the upper side of the plate 20. Thus, vertical movement of the plank 43 from the plate 20 is prevented. A pin 421 is fit in an aperture (not numbered) defined in the plank 43. Another pin 422 is fit in another aperture (not numbered) defined in the plank 43. Thus, horizontal movement of the plank 43 from the plate 20 is prevented.

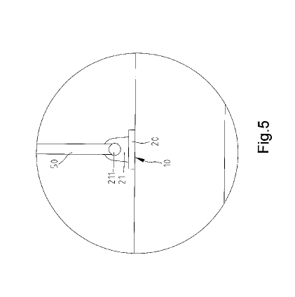

Referring to FIGS. 4 and 5, the truck is loaded with cargos. The cargos are fastened to the truck by means of a plurality of ropes 50. Each end of each rope 50 is tied to a specific fastening apparatus as shown in FIGS. 2 and 3. Thus, each end of each rope 50 is inserted in the aperture 211 defined in the ear 21 of a related fastening apparatus. Thus, the cargos are fastened on the truck by the ropes 50 that are tied to the fastening apparatuses. During the process of fastening the cargos on the truck, there is no need to take the second fastening device 40 from the plate 20.

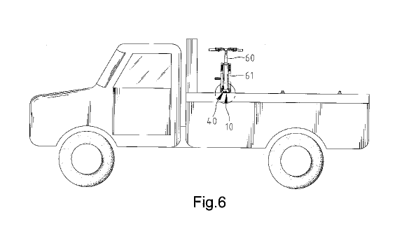

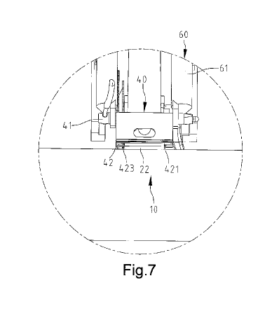

Referring to FIGS. 6 and 7, the truck is loaded with a bicycle 60. The bicycle 60 is fastened to the truck by means of the fastening apparatus 10. To fasten the bicycle 60 on the truck, the front wheel (not shown) is taken from the front fork 61 of the bicycle 60. The front fork 61 is put on a rod (not numbered) of the restraining device 41 and clamped by means of a quick-release element (not numbered). During the process of fastening the bicycle 60 on the truck, there is no need to take the first fastening device 21 from the plate 20.

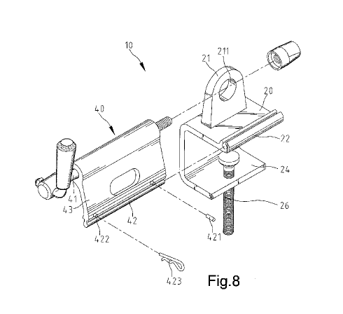

FIG. 8 shows a fastening apparatus 10 according to a second embodiment of the present invention. The second embodiment is similar to the first embodiment except for including a vise instead of the plate 20, the screw 23, the pad 31 and the clip 30. The vise includes a body and a screw 26. The body includes an upper plate 20, a lower plate 24 and a wall (not numbered) formed between the upper plate 20 and the lower plate 24. The upper plate 20 of the body of the vise of the second embodiment is similar to the plate 20 of the first embodiment.

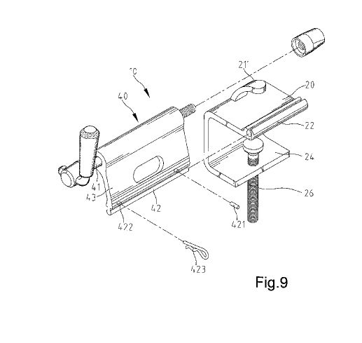

FIG. 9 shows a fastening apparatus 10 according to a third embodiment of the present invention. The third embodiment is similar to the second embodiment except for including a hook 21′ instead of the ear 21.

The present invention has been described through the detailed description of the embodiments. Those skilled in the art can derive variations from the embodiments without departing from the scope of the present invention. Therefore, the embodiments shall not limit the scope of the present invention defined in the claims.

What is claimed is:

1. A fastening apparatus comprising:
an installing device for installment on a truck;
a first fastening device provided on the installing device for fastening a rope; and
a second fastening device provided on the installing device for fastening a front fork of a bicycle.

2. The fastening apparatus according to claim 1 wherein the installing device comprises:
a plate comprising an upper side and a lower side opposite to the upper side, wherein the first and second fastening devices are provided on the upper side of the plate;
a screw raised from the lower side of the plate for insertion in an aperture defined in a flat portion of the truck; and
a clip engaged with the screw in order clamp the flat portion of the truck between the plate and the clip.

3. The fastening apparatus according to claim 2 wherein the installing device comprises a pad for provision between the clip and the flat portion of the truck.

4. The fastening apparatus according to claim 2 wherein the first fastening device is an ear formed on the upper side of the plate in order to receive the rope.

5. The fastening apparatus according to claim 2 wherein the first fastening device is a hook formed on the upper side of the plate in order to hook the rope.

6. The fastening apparatus according to claim 2 wherein the second fastening device comprises:
a plank comprising a lower edge and an upper edge opposite to the lower edge, wherein the lower edge of the plank is connected with the upper side of the plate; and
a restraining device provided on the upper edge of the plank in order to fasten the front fork of the bicycle.

7. The fastening apparatus according to claim 6 wherein the plate comprises a groove defined in the upper side, wherein the plank comprises a slide formed along the lower edge for sliding in the groove, thus connecting the plank with the plate.

8. The fastening apparatus according to claim 7 wherein the second fastening device comprises two pins fit in apertures defined in the plank in order to avoid escaping of the plank from the plate.

9. A fastening apparatus comprising:
a vise for installment on a truck;
a first fastening device provided on the installing device for fastening a rope; and
a second fastening device provided on the installing device for fastening a front fork of a bicycle.

10. The fastening apparatus according to claim 9 wherein the vise comprises a body and a screw engaged with the body in order to clamp the flat portion of the truck between a portion of the body and a tip of the screw.

11. The fastening apparatus according to claim 10 wherein the body of the vise comprises an upper plate on which the first and second fastening devices are provided and a lower plate with which the screw is engaged.

12. The fastening apparatus according to claim 11 wherein the first fastening device is an ear formed on the upper plate in order to receive the rope.

13. The fastening apparatus according to claim 11 wherein the first fastening device is a hook formed on the upper plate in order to hook the rope.

14. The fastening apparatus according to claim 11 wherein the second fastening device comprises:
a plank comprising a lower edge and an upper edge opposite to the lower edge, wherein the lower edge of the plank is connected with the upper plate; and
a restraining device provided on the upper edge of the plank in order to fasten the front fork of the bicycle.

15. The fastening apparatus according to claim 14 wherein the upper plate defines a groove, wherein the plank comprises a slide formed along the lower edge for sliding in the groove, thus connecting the plank with the upper plate.

16. The fastening apparatus according to claim 15 wherein the second fastening device comprises two pins fit in apertures defined in the plank in order to avoid escaping of the plank from the upper plate.
